(19) United States
(12) Patent Application Publication
(10) Pub. No.: US 2009/0116230 A1
(43) Pub. Date: May 7, 2009

(54) Dual light source utility light

(76) Inventor: Wei Young, Long Island City, NY (US)

Correspondence Address: COOPER & DUNHAM, LLP, 30 Rockefeller Plaza, 20th Floor, NEW YORK, NY, 10112, US

(21) Appl. No.: 11/982,829

(22) Filed: Nov. 5, 2007

(51) Int. Cl. F21L 4/04

(52) U.S. Cl. 362/198

(57) ABSTRACT

A portable utility light has a housing with a power source, two elongated extensions extending from the housing, each extension having a lighting element to radiate light independently than the other extension, whereby the lighting elements can be independently positionable to aim radiated light into different regions of space.

### BACKGROUND OF THE INVENTION

1. Field of the Invention

The present invention relates to utility lights and more particularly to a utility light having multiple light sources which can be independently directed to illuminate different regions of space.

2. Background of the Invention

Flashlights and utility lights have been known and used for many years. Some lights have been used for task lighting such as for book reading. These task lights typically have one light source which is moveable relative to a base or housing. One example is U.S. Pat. No. 5,154,483 incorporated by reference herein. This patent relates to a flashlight having a housing adapted to accommodate batteries as a power source, and having an elongated flexible arm in the form of a gooseneck, at the end of which is a light element such as a bulb. The light element can be oriented independently relative to the orientation of the base or housing. When so used, the lighting element will illuminate only one region of space. If more than one region of space is desired to be illuminated two such devices are required, in which case the housing of each device must be anchored or secured. Also, two sets of batteries must be provided, and the user needs to carry around two such devices.

### SUMMARY OF THE INVENTION

An object of the present invention is to provide a utility light having a single housing with a plurality of independently positionable and aimable light sources.

The invention provides a portable utility light comprising a housing adapted to accommodate a source of power, a first elongate extension having a proximate end connected to the housing and a distal portion having a first lighting element to radiate light into a region of space, a second elongate extension having a proximate end connected to the housing and a distal portion having a second lighting element to radiate light into a region of space, the first and second extensions being formed to be easily flexed by hand to assume a plurality of different shapes along their length and can retain their given shape indefinitely, and the first and second elongate extensions having energy transfer means to connect the source of power in the housing to the lighting elements at the distal end of the respective extension, whereby each lighting element can be independently positionable to aim its respective radiated light into a different region of space.

The invention provides a portable utility light comprising a housing adapted to accommodate a source of power, a first elongate extension having a proximate end connected to the housing and a distal portion having a first lighting element to radiate light into a region of space, a second elongate extension having a proximate end connected to the housing and a distal portion having a second lighting element to radiate light into a region of space, the first and second extensions being formed to be easily flexed by hand to assume a plurality of different shapes along their length and can retain their given shape indefinitely, the first and second elongate extensions having energy transfer means to connect the source of power in the housing to the lighting elements at the distal end of the respective extension, whereby each lighting element can be independently positionable to aim its respective radiated light into a different region of space, wherein the housing includes a clip adapted to attach the utility light to an object, wherein the housing has a switch for selectively connecting the source of power to the lighting elements, wherein the housing includes a power circuit which outputs two different levels of power to the lighting elements in response to actuation of the switch, wherein the lighting elements are LEDs, and wherein the elongate extensions are goosenecks.

### BRIEF DESCRIPTION OF THE DRAWING

A better understanding of the objects, features and advantages of the invention can be gained from a consideration of the following detailed description of the preferred embodiment thereof, in conjunction with the appended figures of the drawing, wherein a given reference character always refers to the same element or part and wherein:

FIG. 1 is a perspective view of a portable utility light constructed in accordance with the invention; and

FIG. 2 is a partially exploded view of the light of FIG. 1.

### DETAILED DESCRIPTION OF THE PREFERRED EMBODIMENT

A preferred embodiment of a portable utility light according to the invention will now be described, but the invention is not limited to this embodiment.

The invention provides a portable utility light comprising a housing adapted to accommodate a source of power, a first elongate extension having a proximate end connected to the housing and a distal portion having a first lighting element to radiate light into a region of space, a second elongate extension having a proximate end connected to the housing and a distal portion having a second lighting element to radiate light into a region of space, the first and second extensions being formed to be easily flexed by hand to assume a plurality of different shapes along their length and can retain their given shape indefinitely, and the first and second elongate extensions having energy transfer means to connect the source of power in the housing to the lighting elements at the distal end of the respective extension, whereby each lighting element can be independently positionable to aim its respective radiated light into a different region of space.

The housing may include a clip adapted to attach the utility light to an object. The housing may have a switch for selectively connecting the source of power to the lighting elements. The housing may include a power circuit which outputs two different levels of power to the lighting elements in response to actuation of the switch. The lighting elements may be LEDs. The elongate extensions may be goosenecks.

The invention provides a portable utility light comprising a housing adapted to accommodate a source of power, a first elongate extension having a proximate end connected to the housing and a distal portion having a first lighting element to radiate light into a region of space, a second elongate extension having a proximate end connected to the housing and a distal portion having a second lighting element to radiate light into a region of space, the first and second extensions being formed to be easily flexed by hand to assume a plurality of different shapes along their length and can retain their given shape indefinitely, the first and second elongate extensions having energy transfer means to connect the source of power in the housing to the lighting elements at the distal end of the respective extension, whereby each lighting element can be independently positionable to aim its respective radiated light into a different region of space, wherein the housing includes a clip adapted to attach the utility light to an object, wherein the housing has a switch for selectively connecting the source of power to the lighting elements, wherein the housing includes a power circuit which outputs two different levels of power to the lighting elements in response to actuation of the switch, wherein the lighting elements are LEDs, and wherein the elongate extensions are goosenecks.

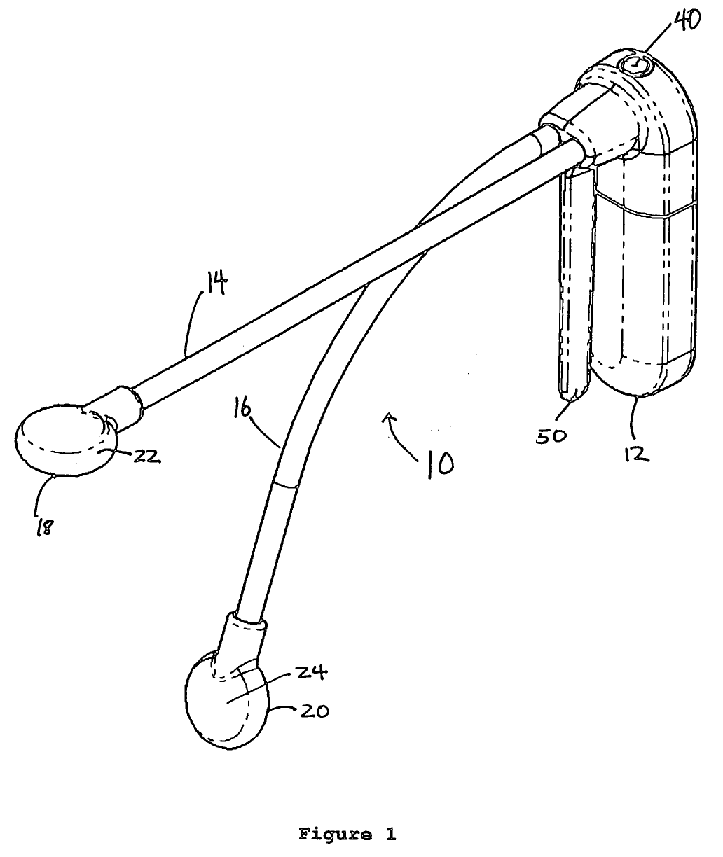

FIG. 1 is a perspective view of an embodiment of a portable utility light in accordance the invention.

The utility light 10 comprises a housing 12 having a battery bay (not shown) for accepting batteries such as AAA batteries. The utility light has two extension pieces 14, 16 in the form of goosenecks extending from the housing 12. The extension pieces have a proximate ends connected to the housing and distal portions having a lighting elements 18, 20. The lighting elements 18, 20 may each be an LED. The elements may be an incandescent lamp or the end of a fiber optic cable. The distal portion of each elongated extension has a domed assembly 22, 24 to house the lighting element, and includes a reflector 26 and a lens 28.

The housing has a power circuit on printed circuit board (PCB) 38 (not shown) and a push button switch 40. The circuit and switch 40 are connected to the battery source and provide power through conductors in the elongated extensions 14, 16 to each LED 18, 20. The power is provided at two different power levels, cycling through OFF, LOW POWER and HIGH POWER by repeated actuations of the push button switch.

The housing has a clip 50 which enables the housing 12 to be attached to a user's belt, the center binding of a book or other object. When attached to a book, the different elongated extensions may direct the lighting elements to the two different face pages of the book. The utility light can also be used to light two different reading materials at the same time, such as a reference book or dictionary, and a book or crossword puzzle.

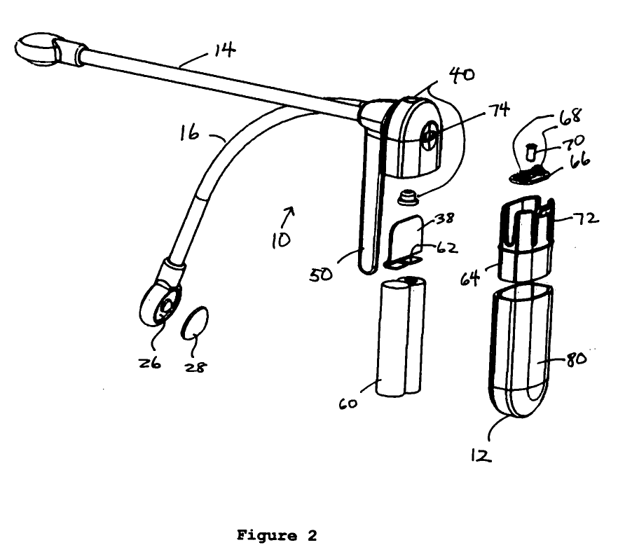

FIG. 2 is a partially exploded view showing the housing 12 separated into an upper and lower portion. The lower portion houses two AAA batteries 60 which engage PCB contact 62. The batteries are housed in a battery housing insert 64, at the bottom of which is a battery bridge 66 with springs 68 held in place by screw 70. The battery housing can be easily removed from the upper housing portion by release button 72 which is received in opening 74 when assembled.

The utility light can be used as task lighting to light an object being worked on from two different perspectives or angles, thereby reducing or eliminating shadows that would appear using only one light.

By providing two different light sources with a common housing, one may provide light in two different regions of space or from two different vantage points easily using only one common housing. Only one set of batteries is needed for the two light sources.

The gooseneck extensions may be coiled around the housing when not in use for storage or transport.

The utility light can rest on the face 80 of the housing opposite the clip 50 or be hung from different objects. When hung, the switch 40 is accessible on top of the housing to enable easy on/off or changing between power settings.

Thus there is provided in accordance with the invention a flashlight that is more versatile than conventional flashlights. The flashlight remedies the drawbacks of conventional flashlights noted above and in particular is easier to use under a variety of conditions than any flashlight known heretofore. Moreover, the flashlight in accordance with the invention can be used as a task light or as a clip-on light and is compact yet has a reach long enough to be brought close to an area requiring illumination in a crowded environment.

Many modifications of the preferred embodiment of the flashlight disclosed above will readily occur to those skilled in the art upon consideration of this disclosure. For example, the length of the extension can be varied within wide limits. Also, the flashlight can be made in different sizes and can be powered by batteries larger or smaller than AAA size. Moreover, as indicated above, the housing 14 may be attached to a portion of the extension different from the illustrated place of attachment; or the housing and extension can be merged into a single elongate member, at least a portion of which is flexible and can retain a given shape indefinitely. Accordingly, the invention is not limited except by the appended claims.

I claim:

1. A portable utility light comprising:
a housing adapted to accommodate a source of power;
a first elongate extension having a proximate end connected to the housing and a distal portion having a first lighting element to radiate light into a region of space;
a second elongate extension having a proximate end connected to the housing and a distal portion having a second lighting element to radiate light into a region of space;
the first and second extensions being formed to be easily flexed by hand to assume a plurality of different shapes along their length and can retain their given shape indefinitely; and
the first and second elongate extensions having energy transfer means to connect the source of power in the housing to the lighting elements at the distal end of the respective extension, whereby each lighting element can be independently positionable to aim its respective radiated light into a different region of space.

2. The utility light according to claim 1, wherein the housing includes a clip adapted to attach the utility light to an object.

3. The utility light according to claim 1, wherein the housing has a switch for selectively connecting the source of power to the lighting elements.

4. The utility light according to claim 3, wherein the housing includes a power circuit which outputs two different levels of power to the lighting elements in response to actuation of the switch.

5. The utility light according to claim 1 wherein the lighting elements are LEDs.

6. The utility light according to claim 1, wherein the elongate extensions are goosenecks.

7. A portable utility light comprising:
a housing adapted to accommodate a source of power;
a first elongate extension having a proximate end connected to the housing and a distal portion having a first lighting element to radiate light into a region of space;
a second elongate extension having a proximate end connected to the housing and a distal portion having a second lighting element to radiate light into a region of space;
the first and second extensions being formed to be easily flexed by hand to assume a plurality of different shapes along their length and can retain their given shape indefinitely; and
the first and second elongate extensions having energy transfer means to connect the source of power in the housing to the lighting elements at the distal end of the respective extension, whereby each lighting element can be independently positionable to aim its respective radiated light into a different region of space;
wherein the housing includes a clip adapted to attach the utility light to an object;
wherein the housing has a switch for selectively connecting the source of power to the lighting elements;
wherein the housing includes a power circuit which outputs two different levels of power to the lighting elements in response to actuation of the switch;
wherein the lighting elements are LEDs; and
wherein the elongate extensions are goosenecks.
